(19) United States
(12) Patent Application Publication
(10) Pub. No.: US 2026/0294028 A1
(43) Pub. Date: Oct. 1, 2026

(54) BUFFER BODY FOR SKI BOOT TONGUE ASSEMBLY

(71) Applicants: AIRPROTECK B.V., HC Rotterdam (NL); DUTCH THINKING MANAGEMENT B.V., HC Rotterdam (NL)

(72) Inventor: Sjoerd VRIJBURG, HC ROTTERDAM (NL)

(21) Appl. No.: 19/476,486

(22) PCT Filed: Jun. 17, 2024
(86) PCT No.: PCT/NL2024/050317

§ 371 Date: Oct. 17, 2025

(30) Foreign Application Priority Data
Apr. 17, 2023 (NL) 2034587

(51) Int. Cl. A43B 5/04; A43B 7/08; B33Y 80/00

(52) U.S. Cl. CPC A43B 5/0405; A43B 5/0433; A43B 7/08; B33Y 80/00

(57) ABSTRACT

The present invention relates to a buffer body for a ski boot tongue assembly, for a ski boot with a shaft and a tongue providing a buffer effect between the ski boot and a part of the human body that is arrangeable in the ski boot, such as a part of the lower leg, wherein the buffer body comprises: —a body side that is directed towards the body during use providing a support effect for supporting of the body, —a ski boot side that is directed away from the body during use, —a circumference edge bordering the body side and the ski boot side, —a spatial lattice structure with open space between ribs forming the lattice structure, wherein—the spatial letter structure comprises a buffer material with resilient properties.

The present invention relates to a buffer body for a ski boot tongue assembly for a ski boot with a shaft and a tongue which provides a part of the human body that may be arranged in the ski boot by processing between the ski boot and a part of the lower leg. In addition, the present invention concerns a ski boot tongue assembly comprising such a buffer body. In addition, the present invention relates to a ski boot comprising such a ski boot tongue assembly.

Skiing is a widely practiced sport for which a ski boot is used. Such a ski boot is made up of a part containing the foot and a shaft that extends above it around a part of the lower leg. It is relevant that on the one hand the ski boot is suitable for controlling the ski and on the other hand it provides such comfort comfortable to wear that the body is not affected. In other words, it is of relevance to prevent pain or injury from the ski boot while providing sufficient guidance to the ski while skiing.

Previous solutions have been provided for this and costly solutions were provided for personalizing the ski boot.

In order to improve such prior art, the present invention provides a buffer body for a ski boot tongue assembly, for a ski boot with a shaft and a tongue providing a buffer effect between the ski boot and a part of the human body that is arrangeable in the ski boot, such as a part of the lower leg, wherein the buffer body comprises:
a body side that is directed towards the body during use providing a support effect for supporting of the body,
a ski boot side that is directed away from the body during use,
a circumference edge bordering the body side and the ski boot side,
a spatial lattice structure with open space between ribs forming the lattice structure, wherein
the spatial letter structure comprises a buffer material with resilient properties.

Such a buffer body according to the present invention provides advantages over the prior art which solve several disadvantages of the prior art. An advantage of the buffer body is that the application of the spatial lattice structure provides a ventilating effect that is not feasible with foam materials according to the prior art. Air can move freely through the lattice structure, and moisture may be dissipated through the lattice structure. Foam materials are essentially open-cell or closed-cell materials. Although open-cell foam materials provide the option for a fluid to migrate through them, such a property is suitable for drying such a foam. However, it is of relevance to note that the more open an open cell foam is, the more vulnerable the open cell foam is and the less applicable such an open cell foam is for use in a ski boot where it is heavily loaded between the leg and the shaft.

A further advantage of the buffer body according to the present invention or preferred embodiments thereof relates to properties related to heat or moisture management that is advantageous to human skin. Moisture accumulation at the site of the human skin during physical exertion because it is enclosed in a ski boot is significantly reduced by this buffer body. Furthermore, such a buffer body reduces or prevents the formation of blisters or injuries such as those caused by impacts of the body against the ski boot, generally referred to as ‘shin bang’.

A further advantage of the present invention occurs when the leg is pushed against the lattice structure during skiing and that this push-in is lifted again during a movement of the leg away from the lattice structure. Such movements occur when, during a turn, the skier pushes from the inside of the shaft of the ski boot against the inside of the shaft of the ski boot and thus against the inside of the lattice structure of the buffer body for the purpose of steering the skis. This drives air out of the buffer body or out of the lattice structure of the buffer body. When the pressure at the lattice structure is released, it is returned to its starting position and air is sucked inwards towards the inside of the lattice structure.

This effectively refreshes the air within the lattice structure at least partially and expels moisture present or absorbed in the air outwardly outward the lattice structure and thus out of the ski boot. The more actively the skier performs these movements, the more active the air exchange or ventilation is carried out. Thereby, a positive effect is that especially when the skier is active with such movements, there is also a greater need to ventilate.

According to a preferred embodiment, the lattice structure at the body side comprises a body contact lattice suitable for clothing contact, such as a sock contact or pants contact, and/or body contact. This provides an advantageous manner that the lattice structure or the body contact with it during use preferably functions in a skin-sparing manner. For the specific structure of the lattice, the presence of the said sock and/or pants is advantageous because of the protective effect that they provide to the skin in themselves. It is of relevance for the structure of the lattice or body contact lattice that the contact with the skin preferably functions in a skin-sparing way, while the further functioning of the buffer body functions as the buffer. It is advantageous that the spaciousness of the lattice structure at the body side provides a sufficient degree of flatness for the advantageous skin contact.

According to a further preferred embodiment, the lattice structure at the ski boot side comprises a tongue attachment lattice suitable for arrangement in the ski boot tongue assembly or at an outer shell thereof, such as by means of a fastening operation such as gluing or welding. Preferably, such a ski boot tongue assembly shall comprise the outer shell arranged between the buffer body and at least one shell or the shaft of a ski boot during use. An advantage of these preferred embodiment is that a sufficient or maximum surface area is provided for the lattice structure for the purpose of arranging and/or attaching the lattice structure to the ski boot tongue assembly. Operations that are provided for this comprise bonding or, for example, ultrasonic welding. In an alternative manner, it is considered that the production of the lattice structure may be embodied with such an outer shell as a substrate.

According to a further preferred embodiment, the buffer body comprises at least one ventilation opening to the outside of the ski boot. This effectively increases the benefits of ventilation. Preferably, the ventilation opening is located at the top of the buffer body. In the case of a ski boot with an almost completely or completely closed shaft, removal of moisture, moist air or heat from the top of the shaft are achievable. The buffer body may extend above the edge of the shaft of the ski boot, allowing a larger part of the perimeter edge or even part of the ski boot side or the body side to be used for ventilation or as a ventilation opening. Preferably, the ventilation opening is arranged in a part of the perimeter edge arranged at the top of the buffer body.

According to a further preferred embodiment, the lattice structure comprises a ventilation-promoting lattice structure. To this end, the lattice structure is preferably equipped with air propelling means for pushing air during movements made by the lattice structure. Such movements lattice structure are made under the influence of pushing against it by the leg and stopping pushing against it by the leg. Preferably, the ventilation-promoting lattice structure comprises aerodynamic shapes or flaps of the or at predetermined ribs of the lattice structure. Preferably, compressible lattice structure elements are provided for this purpose. In further preference, the compressible lattice structure elements are compressible by compressive force by means of a respective or adjacent part of the human body.

According to a further preferred embodiment, the spatial lattice structure is resiliently compressible. Such a preferred embodiment has the advantage of achieving a resilient effect on the human body or its organs.

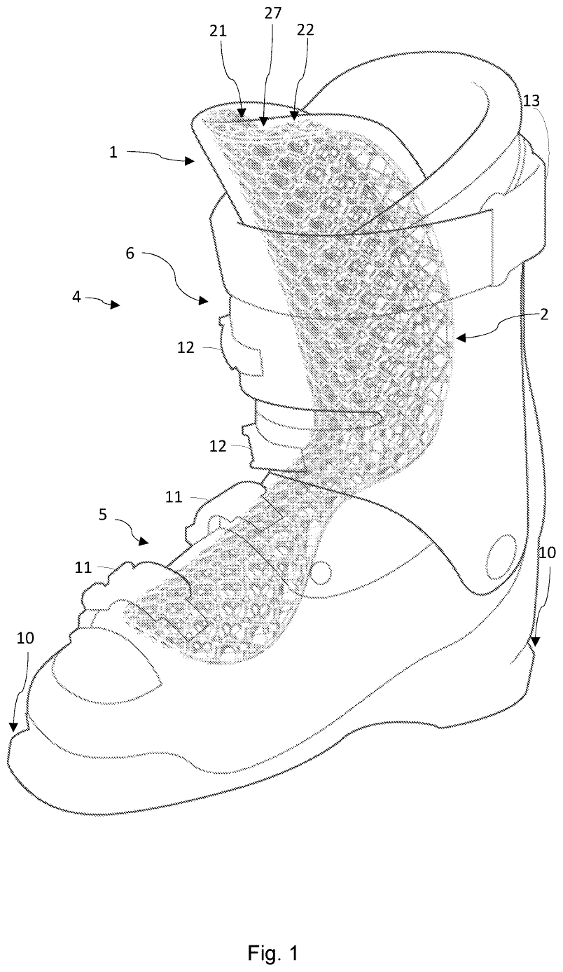

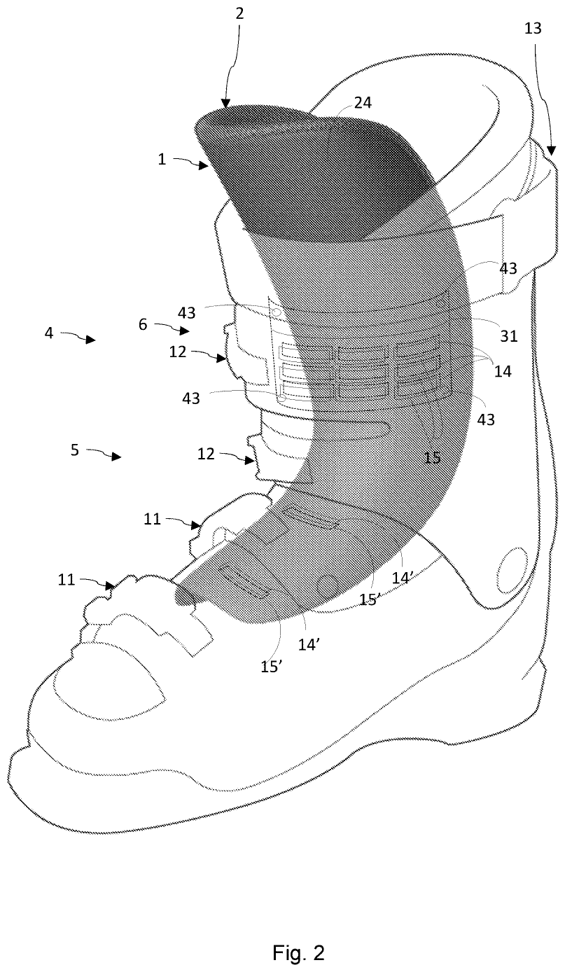

According to a further preferred embodiment, wherein the spatial lattice structure provides a starting shape when the spatial lattice structure is arranged in the ski boot, as arranged in the ski boot without a thereon exerted force. Such an output form is the one in which the lattice structure is located without loading. Even when the lattice structure is arranged in the ski boot, it has a starting shape, although in this starting shape there is a deformation in itself due to the manner in which the buffer body is arranged in the ski boot. For example, the ski boot is arranged in the ski boot as part of a ski boot tongue assembly. As a result, deformation occurs due to the manner in which the buffer body is arranged at this ski boot tongue assembly or an outer shell thereof. Deformation is also possible due to the arrangement of the ski boot itself, such as the arrangement in relation to a foot-enveloping part or a shaft part of the ski boot. This results in an arrangement of the buffer body, as generally shown in FIG. 1 or in FIG. 2, where the output shape is determined as the shape of the buffer body in such arrangement without the presence of a foot or leg. When wearing the ski boot or while skiing, a foot with the respective part of the lower leg is present in the ski boot. Even when that is the case and the person is substantially at rest or standing upright, there is a starting shape. During loading by the body, such as during forward movement of the lower leg in relation to the position in which the person is substantially at rest, the buffer body is depressed and it is brought out of the starting shape, when the person moves the leg up or backward again, the buffer body returns to the starting shape. In this case, the spatial lattice structure is resiliently compressible from the starting shape.

According to a further preferred embodiment of execution, the buffer body or its lattice structure comprises a relief slit for relieving the tibialis anterior and/or a tendon of the tibialis anterior. The tibialis anterior is a muscle with a tendon that is substantially located at the front of the lower leg. When the tibialis anterior is tightened, it forms a bulge that extends beyond the anterior edge of the tibia, or the bone with the flat side at the front of the tibia. With this, the invention or the present preferred embodiment of execution provides the advantage that this tibialis anterior and/or a tendon thereof is relieved in relation to the ski boot during use of the ski boot or tightening of this muscle.

To this end, it is preferable to arrange the relief slit at the center of the inside of the buffer body, preferably from the top to the bottom.

According to a further preferred embodiment, the spatial lattice structure is provided with a shin support comprising a tibia contact surface, preferably comprising a tibia contact surface with a congruence with the surface of the tibia. In this case, the tibia is the bone with the flat side at the front of the lower leg, or the tibia or tibia. An advantage of such shin support is that force may be applied to it by means of the flat part of the shin. The congruence between the tibia and the tibia contact surface provides an opportunity to provide a lot of control by means of the tibia with the flat side at the tibia contact surface. This makes the ski very directly controllable by consciously applying force by means of the shin bone of the lower leg.

Otherwise, the shin contact area is substantially flat. This is an advantageous elaboration of the said congruence between the tibia and the tibia contact surface.

According to a further preferred embodiment, the tibia contact surface is arranged in such a manner that it lies flat against the tibia during use. It is advantageously provided that when the buffer body is arranged in the ski boot, the orientation of the tibia contact surface is such that it is essentially in line with the orientation of a lower leg to be inserted into the ski boot with the tibia. This advantageously ensures that the position of the tibia contact surface when the buffer body is arranged in the ski boot is substantially in the starting shape. Alternatively, it is provided that after the lower leg has been inserted into the ski boot, the starting shape is such when the spatial lattice structure is against the tibia when it is in a neutral resting position, such as upright.

According to a further preferred embodiment, the relief slit is arranged along the shin support. This has been advantageously achieved that the shin support may achieve a maximum contact surface with the tibia in combination with the relief slit providing maximum relief of the tibialis anterior or a tendon thereof.

According to a further preferred embodiment of design, the buffer body comprises a lower leg muscle relief surface with a curved shape in order to envelop the lower leg muscles substantially in a form-fitting manner. This relieves the lower leg muscles adjacent to the tibialis anterior at the outside of the lower leg. The combination of these muscles, in contrast to the flat shape of the tibia, forms a round shape at the front of the tibia opposite the tibia. The curved shape of the lower leg muscle relief surface reduces pressure on these muscles while they are being used. The mutual interaction of the lower leg muscle relief surface and the tibia contact surface causes the tibia to be used precisely for the transmission of forces from the leg to the ski boot and the lower leg muscles are relieved, as is the anterior tibialis, which is located substantially in the middle front of the lower leg between the tibia and the other lower leg muscles.

For this purpose, it is therefore preferable to locate the lower leg muscle relief surface in relation to the shin support at the other side of the relief slit as seen from the top.

According to a further preferred embodiment, the body side comprises a body contact material, such as a foam or a textile, with moisture-permeable properties, suitable for clothing contact, such as sock contact or pants contact, and/or body contact. By means of such a body contact material, the contact between the buffer body and the spatial lattice structure or its body contact lattice is furthermore improved. It is advantageous that such material releases moist as quickly as possible into the air present in the buffer body.

According to a further preferred embodiment, part of the lattice structure forming the shin support is executed with a relatively higher stiffness than part of the lattice structure forming the lower leg muscle relief surface. This further increases the ability of such a material to absorb forces exerted by means of the tibia. In addition to increasing the ability to absorb these forces, the relief that is realized by means of the lower leg muscle relief surface is further improved.

Further preferably, the lattice structure of the buffer body comprises material containing at least one elastomeric PU. It is considered that different characteristics of materials in different parts of the lattice structure may be achieved by different variants of the material used, such as at least one elastomeric PU, and may be achieved by design of the spatial lattice structure, such as by means of shorter and longer ribs, thicker and thinner ribs, ribs with a thickness gradient along their length. Furthermore, it is considered that the design of the ribs in different spatial shapes may be applied within the understanding of the present invention.

In this case, the lattice structure is preferably built up using cell shapes such as tetrahedal, centroidal and/or voronoid shapes. For example, a cell shape is defined as the shape of a part of the spatial structure formed by surrounding ribs, similar to the ribs of a cube define the cube.

Preferably, the perimeter edge of the buffer body should be provided with at least one ventilation opening, in further preference with several ventilation openings, preferably with inlet openings and exhaust openings.

A further aspect according to the present invention concerns a ski boot tongue assembly comprising a buffer body according to the previous aspect, comprising an outer shell for arrangement against an inside of a shaft or shell material of a ski boot. This aspect according to the present invention provides advantages as indicated by the above aspect.

According to a preferred embodiment of this aspect, the outer shell of the ski boot tongue assembly is equipped with at least one ventilation opening to provide ventilation.

In further preference, at least one vent is designed as a slot or elongated opening. An advantage of such a slot shape is that ventilation is also possible through respective openings in a respective part of a shell or shaft of a ski boot in which the ski boot tongue assembly is used.

Further preferably, the ski boot tongue assembly comprises closing means, such as a cover plate or slide, for closing the at least one ventilation opening.

According to a further preferred embodiment, such closing means comprise a magnetic attachment for the pur-pose of attachment of the ski boot tongue assembly.

A further aspect according to the present invention concerns a ski boot comprising a ski boot tongue assembly according to the above aspect. A ski boot according to this aspect of the invention provides advantages as indicated in light of either of the above aspects.

According to a preferred embodiment of this aspect, the ski boot comprises at least one ventilation opening in a respective part of a shell or shaft thereof. In conjunction with a ventilation opening of the ski boot tongue assembly, this allows ventilation between the buffer body and the outside of the ski boot to be achieved.

Further preferably a ventilation opening of the ski boot tongue assembly overlaps with a respective ventilation opening of the ski boot.

Further preferably, the ski boot comprises closing means, such as comprising a cover plate or slide to close off at least one ventilation opening. It is advantageous to provide that a closure of the ventilation openings of the ski boot tongue assembly and/or the ski boot is magnetically attached or attachable to the ski boot tongue assembly and/or the ski boot assembly, preferably at the inside of the ski boot and/or at the outside of the ski boot tongue assembly.

Further preferably, at least one vent is slot-shaped. An advantage of this is that when fastening the fasteners of the ski boot, an overlap of the slots remains possible with different degrees of tightening of the fasteners.

Further advantages, features and details of the present invention will be described in more detail below with reference to one or more preferred embodiments with reference to the attached figures. Similar, but not necessarily identical, parts of different preferred embodiments are indicated by the same reference figures.

FIG. 1 shows a cutaway representation in perspective of a ski boot with a buffer body arranged therein according to a preferred embodiment according to the present invention.

FIG. 2 shows a further cutaway representation in perspective of a ski boot with a ski boot tongue assembly arranged therein according to a preferred embodiment according to the present invention.

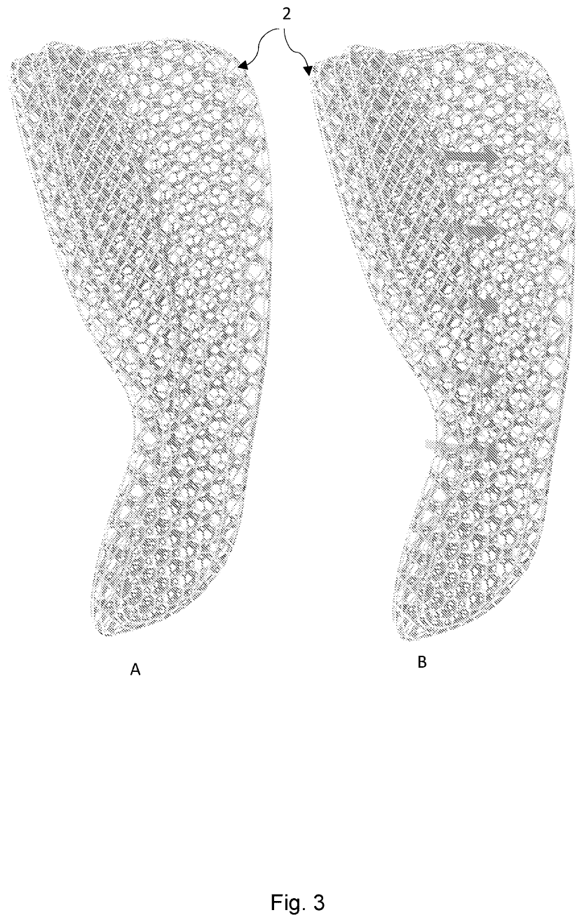

FIG. 3 shows a perspective representation of a buffer body according to a preferred embodiment according to the present invention.

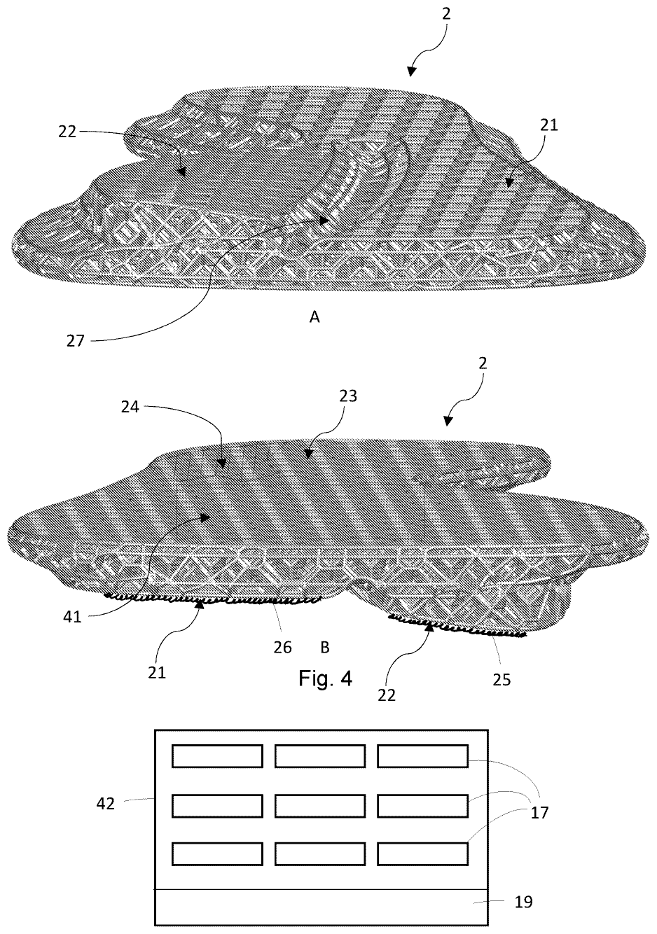

FIG. 4 shows a further representation in perspective of the buffer body according to a preferred embodiment according to the present invention.

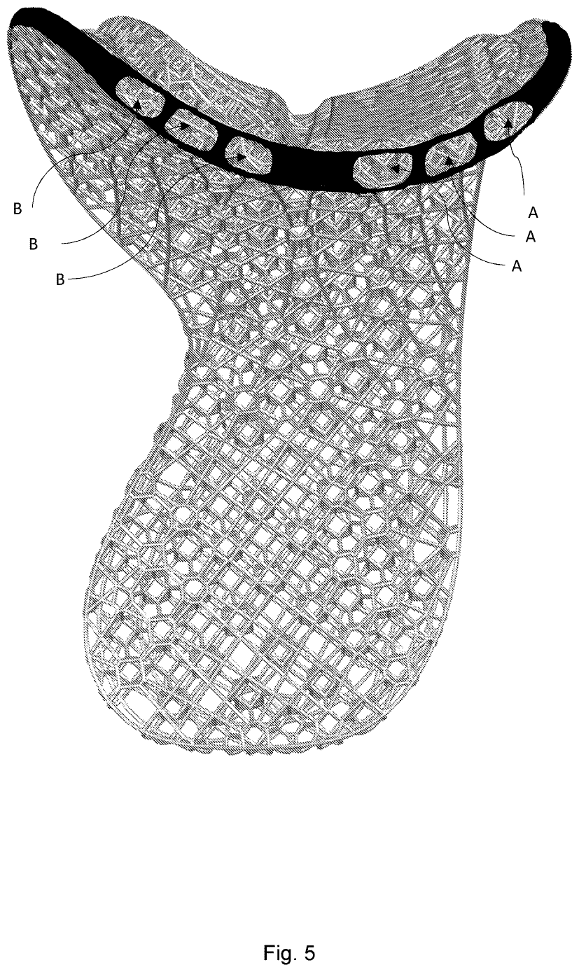

FIG. 5 shows a further preferred embodiment of execution according to the present invention.

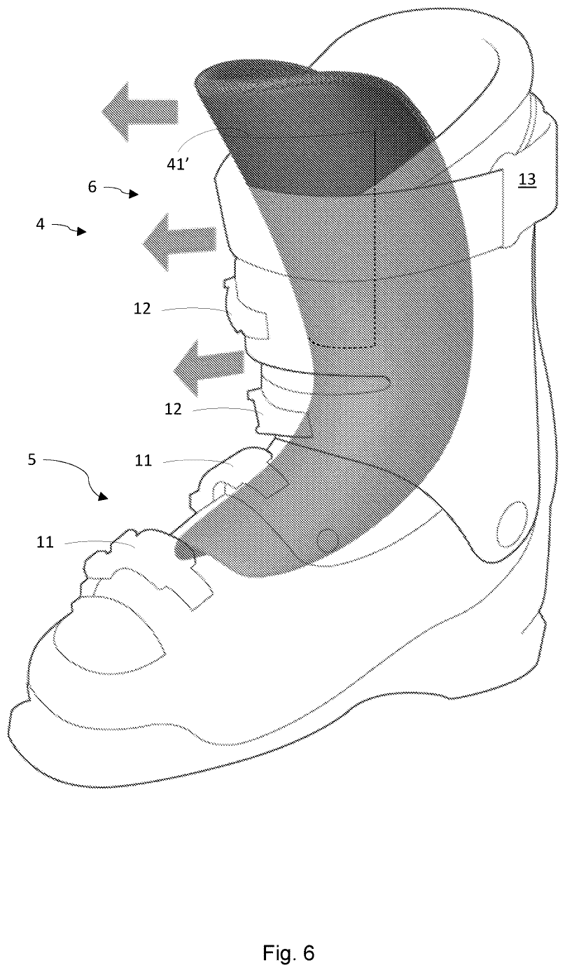

FIG. 6 shows a further representation in perspective of a ski boot with a ski boot tongue assembly arranged therein according to a preferred embodiment according to the present invention.

A first preferred embodiment (FIG. 1) according to the present invention relates to a buffer body 2. It is preferably arranged in a ski boot tongue assembly 1. The same is preferably arranged in a ski boot 4. According to the state of the art, the construction of the ski boot it-self is possible in many ways and the ski boot shown here is just one of the many possibilities. The ventilation openings shown in the ski boot according to FIG. 2 are measures of preferred embodiments according to the present invention in order to serve in conjunction with ventilation openings of preferred embodiment of the ski boot tongue assembly according to this invention or a preferred embodiment thereof.

In general, the ski boot comprises a number of closures. The ski boot shown has closures 11 for a foot part 5 of the ski boot. Furthermore, the ski boot closures shown have 12 closures for a shaft part 6 of the ski boot. In terms of ski boots, a shaft section is also referred to as ski boot cuff or shaft. At the top of the shaft section 6 is a further strap 13 arranged for tightening the top of the shaft section.

In general terms, a tongue is arranged within a shaft section of the ski boot and it may extend into the foot part of a ski boot. An advantage of a buffer body according to the present invention is that ventilation is realized from this foot part of the ski boot.

As may be seen in FIG. 1, a buffer body 2 is arranged in the ski boot and extends from the top of the foot part 5 by means of a curve to the top of the shaft part 6 and extends over some distance above it according to the preferred embodiment.

The buffer body is constructed as a spatial lattice structure made of ribs that together form cells of the lattice structure. The ribs of the lattice structure are made of a resilient and deformable material. The individual cells of the lattice structure are resilient and deformable. The lattice structure as a whole is resilient and malleable. Preferably, the spatial lattice structure is formed using a method of 3D printing. An advantage of such a process is that a structure may be manufactured with several layers of cells on top of each other that are independently deformable or definable. A further advantage is that the thickness of each rib may be defined separately. The resilience, stiffness, hardness, softness or compressibility of different parts of the spatial lattice structure may therefore be defined or determined independently from each other.

A particular advantage here is that, for example, the tibia contact surface may be defined relative to the lower leg muscle relief surface with a relatively high stiffness. A further advantage is that within the spatial lattice structure a free transport of fluids, comprising air and water, is possible. As a result, considerable ventilation may be achieved. Where, according to the state of the art, a foam material is used for the filling of the tongue, the application of the lattice structure according to the present invention or a preferred embodiment thereof has advantageously created a material which confers advantages which could not be achieved or envisaged with the foam alone.

Air may move freely within the lattice structure or may be propelled within the lattice structure by the shape of ribs or flaps attached to ribs during deformation of the ribs. Such deformation of the ribs is done by applying a load to the ribs or by removing such load from the ribs. This is done by the skier by bending the leg for the purpose of steering the ski and straightening the leg, which the skier does alternately while skiing for the purpose of making turns or braking with the ski.

The ski boot tongue assembly 1 according to FIG. 2 is a buffer body 2 with an outer shell 24. The outer shell 24 is preferably a shell material or a sheet material, such as a flexible plastic with a suitable or predetermined stiffness. Preferably, the outer layer 24 is pre-formed to the shape it takes inside the ski boot. Providing this shape at the outer shell 24 is preferably done after attaching the buffer body to the outer shell.

Buffer body 2 (FIG. 4) is constructed comprising the said lattice structure with cells and ribs. The buffer body 2 generally comprises the tibia contact body 22′ with tibia contact surface 22 and the lower leg muscle relief surface 21 with the relief slit 27 in between for relieving the tibialis anterior. In the right ski boot, the tibia contact surface is at the left side and the lower leg muscle relief surface is at the right side. In the left ski boot, the tibia contact surface is at the right side and the lower leg muscle relief surface is at the left side. In both cases, the relief slit is located between these at the front.

The tibia contact surface 22 is arranged with a direction that corresponds to the direction of a flat surface of the tibia of the lower leg during use. This is shown in FIG. 1, of a right ski boot, where the buffer body is arranged inside the ski boot. Compared to the representation in FIG. 4, during use in the ski boot, the buffer body is curved, so that the direction of the surface of the tibia contact surface 22 is aligned with the flat surface of the tibia of the lower leg.

When the buffer body is arranged in a ski boot, the relief slit 27 runs from top to bottom at the point of the anterior tibialis and a tendon thereof which is the anterior muscle of the lower leg. This anterior muscle protrudes in front of the anterior edge of the tibia when this muscle is contracted. Due to the presence of the relief slit 27, the relief slit 27 ensures that this muscle is not or less burdened by the buffer body than without the presence of this relief slit 27.

The lower leg muscle relief surface 21 is located at the opposite sides of the buffer body. During use in the ski boot, the lower leg muscle relief surface is arranged slightly retracted relative to the lower leg in relation to the tibia contact surface, so that although contact is possible between the lower leg muscles and the lower leg muscle relief surface, this contact is less pronounced or less intense in relation to the contact between the tibia and the tibia contact surface. As a result, it has been advantageously achieved that the muscles of the lower leg may be tightened during skiing with a relatively low burden on the lower leg muscle relief surface compared to the burden that the tibia experiences from the tibia contact surface. In other words, the curvature of the shin support, the lower leg muscle relief surface, is relatively wide around the lower leg compared to the contact area of the tibia contact surface.

For ventilation, openings are available at the top of the buffer body 2 and/or the ski boot tongue assembly 1. Such openings are provided as different embodiments. An embodiment involves leaving the perimeter edge of the buffer body or its spatial lattice structure free. As a result, free inflow and outflow of air in relation to the spatial lattice structure has been achieved. In an alternative way, partial closure by means of a textile material is provided, as shown in FIG. 2. Within the scope of the present invention, a size of mesh openings of such a textile material may be selected by a craftsman in the field. A further alternative (FIG. 5) is to close off the perimeter edge with openings. Such openings may be considered, for example, closable by means of valve material or flap material. It is also provided that part of the openings is provided for the inlets of air in the direction of the arrow A and a part is provided for the outlets of air in the direction of the arrow B. It is provided that the ribs of the spatial lattice structure or flaps attached to it create an air flow in this direction by means of an aerodynamic effect on the air.

Ventilation is provided according to further preferred embodiments by means of openings made in the outer shell of the ski boot tongue assembly. If such openings are located above the shaft of the ski boot, they communicate directly with the outside air.

In addition, such openings 14 in the outer shell of the ski boot tongue assembly are shown, which are located inside the shell of the ski boot. In such a case, openings 15 are also provided in the shell of the ski boot. With this, these openings 14,15 communicate with the outside air, allowing air to transport from the buffer body to the environment and allowing air to move from the environment to the buffer body.

By means of the ventilation, it has been realized in an economical manner that heat may be dissipated. As a result, it has also been achieved in an economical manner that moisture may be removed. This is advantageous because moisture in the ski boot is linked to the development of conditions, such as injuries or blisters.

Depending on weather conditions, ventilation is more or less desirable. In case of precipitation or low temperatures, for example, it is desirable to have less ventilation. To this end, closing means are provided for closing respective ventilation openings. Preferably, such closing means are arranged between the shaft and the ski boot tongue assembly or its outer shell. For example, there are sliders for closing at least one opening, such as per opening, per number of openings or per all openings at once. Alternatively, a magnetic sheet has been provided that may be attached to the openings for the purpose of closing these. Preferably, an excised portion 41, such as in the form of a rectangle, from the outer shell 24 is provided.

For this purpose, a cover plate 42, as may be implemented as a magnetic sheet or parts of magnetic sheet, is shown with openings 17. If the cover plate 42 with the strip 19 are arranged at the top, there is ventilation through overlapping openings and if the cover plate is arranged with strip 19 at the bottom, the ventilation is closed because the openings do not overlap.

A particularly advantageous variant of the magnetic sheet is a magnetic sheet with openings in which, for ventilation, the openings of the magnetic sheet overlap with the openings of the outer shell or overlap with the openings of the shell of the ski boot. If no ventilation is desired, this magnetic sheet may be applied upside down in such a manner that all openings are covered by the magnetic sheet. Provision is made for the attachment of magnets to the ski boot tongue assembly or ski boot for cooperation with magnetic material of the magnetic sheet. If ventilation is desired, the magnets of the ski boot tongue assembly or the ski boot work together with the magnetic material of the magnetic sheet in such a manner that the openings overlap and if ventilation is not desired, the magnets of the ski boot tongue assembly or the ski boot work together with magnetic material of the magnetic sheet in such a manner that the openings do not overlap and therefore no ventilation is available. The user only needs to attach the magnetic sheet with the correct direction towards the front or the back, whereby the magnetic effect ‘clicks’ the magnetic sheet into the correct position. A degree of ventilation may therefore be achieved by choosing a magnetic sheet with larger or smaller openings with the same very easy method of application.

The invention in question or a preferred embodiment of invention relates advantageously to a ski boot tongue assembly, which is provided for at a particularly advantageously for a ski boot. Aspects of increasing the wearing comfort of the support properties for tibia or tibia support comprise sparing the skin of the tibia, sparing muscles of the lower leg and/or sparing the tibialis anterior or a tendon thereof.

A further aspect according to the present invention is to a process comprising steps for measuring the shape of a tibia, preferably including the ankles and the foot providing a measurement, based on the measurement generating of printing data for printing of a spatial lattice structure according to a further aspect according to the present invention. A considered intermediate step is to generate a spatial model of the tibia, preferably including the ankles and foot. This makes it possible to produce a personalized buffer body in an economical way. According to a further preferred embodiment according to the present invention, when forming the buffer body, specific shape properties of the inside of a ski boot are taken into account.

In a further advantageous way, it is provided that parts of the buffer body are formed on the basis of or comprising a foam material. For example, it is provided that a tibia contact body 22′ is made of a foam material with a predetermined stiffness. In further preference, it is internally provided with ducts encompassing the spatial lattice structure as proposed in this specification for providing ventilation through these ducts in addition to the properties of the foam material. This provides combined advantages of a foam material and the spatial lattice structure. In further preference, the spatial lattice structure forming such channels is glued into the foam material of the rest of the tongue and/or buffer body for the benefit of the tibia contact surface.

The present invention is described in the foregoing on the basis of preferred embodiments. Different aspects of different embodiments are expressly considered disclosed in combination with each other and in all combinations that on the basis of this document, when read by a skilled person of the area of skill, fall within the scope of the invention or are deemed to be read with the disclosure of this document. These preferred embodiments are not limitative for the scope of protection of this document. The rights sought are defined in the appended claims.

1. Buffer body for a ski boot tongue assembly, for a ski boot with a shaft and a tongue providing a buffer effect between the ski boot and a part of the human body that is arrangeable in the ski boot, such as a part of the lower leg, wherein the buffer body comprises:
a body side that is directed towards the body during use providing a support effect for supporting of the body,
a ski boot side that is directed away from the body during use,
a circumference edge bordering the body side and the ski boot side,
a spatial lattice structure with open space between ribs forming the lattice structure, wherein
the spatial letter structure comprises a buffer material with resilient properties.

2. Buffer body according to claim 1 wherein the lattice structure at the body side comprises a body contact lattice suitable for clothing contact, such as sock contact or pants contact, and/or body contact.

3. Buffer body according to claim 1 wherein the letter structure at the ski boot side comprises a tongue attachment lattice suitable for arranging in the ski boot tongue assembly, such as by means of a fastening operation such as viewing or welding.

4. Buffer body according to claim 1 comprising at least one ventilation opening towards the outside of the ski boot.

5. Buffer body according to claim 4 wherein the vent is located at a top side of the buffer body.

6. Buffer body according to claim 4 wherein the ventilation opening is arranged in a part of the circumference edge that is arranged at the top of the buffer body.

7. Buffer body according to claim 1 comprising a ventilation-promoting lattice structure.

8. Buffer body according to claim 7 wherein ventilation for the lattice structure comprises compressible lattice structure elements.

9. Buffer body according to claim 8 wherein the compressible lattice structure elements are compressible by compressive force by a respective or adjacent part of the human body.

10. Buffer body according to claim 1, wherein the spatial lattice structure is resiliently compressible.

11. Buffer body according to claim 1, wherein the spatial lattice structure provides a starting shape when the spatial lattice structure is arranged in the ski boot, as arranged in the ski boot without a thereon exerted force.

12. Buffer body according to claim 11 wherein the spatial lattice structure is resiliently compressible from the starting shape.

13. Buffer body according to claim 1 comprising a relief slit for relief of the tibialis anterior and/or a tendon of the tibialis anterior.

14. Buffer body according to claim 13 wherein the relief slit is substantially centrally arranged at the inside of the buffer body, preferably extending from the top to the bottom.

15. Buffer body according to claim 1, wherein the spatial lattice structure is provided with a tibia support comprising a tibia contact surface, preferably comprising a tibia contact surface with a congruence with the surface of the tibia.

16. Buffer body according to claim 15 wherein the body side wherein the tibia contact surface is essentially flat.

17. Buffer body according to claim 15 wherein the tibia contact surface is arranged such that it lies flush against the tibia during use.

18. Buffer body according to claim 1, wherein the relief slit is arranged along the shin support.

19. Buffer body according to claim 1 comprising a lower leg muscle relief surface with a curved shape in order to envelop the lower leg muscle substantially in a form adjacent surrounding manner.

20. Buffer body according to claim 19 wherein the lower leg muscle relief surface is at the opposite side of the relief slit arranged relative to the shin support.

21. Buffer body according to claim 1, wherein the body side comprises a body contact material, such as a foam or a textile, with moisture-permeable properties, suitable for clothing contact, such as sock contact or pants contact, and/or body contact.

22. Buffer body according to claim 1 wherein a part of the lattice structure forming the tibia support is constructed with a relatively higher stiffness than a part of the lattice structure forming the lower leg muscle relief surface.

23. Buffer body according to claim 1, wherein the lattice structure comprises at least one elastomeric PU.

24. Buffer body according to claim 1, wherein the lattice structure is formed using cell shapes as encompassing tetrahedal, centroidal and/or voronoid shapes.

25. Ski boot tongue assembly comprising a buffer body according to claim 1, the ski boot tongue assembly comprising an outer shell for arrangement against an inside of a shaft or shell material of a ski boot.

26. Ski boot tongue assembly according to claim 25 wherein the outer shell is provided with at least one ventilation opening for the purpose of providing ventilation.

27. Ski boot tongue assembly according to claim 26, where at least one vent is made out as a slot or elongated opening.

28. Ski boot tongue assembly, according to claim 26, comprising closing means, such as a valve, plate or slide, for closing of the at least one ventilation opening, preferably comprising a magnetic coupling with the outer shell.

29. Ski boot comprising a ski boot tongue assembly according to claim 1.

30. Ski boot according to claim 29 comprising at least one ventilation opening in a respective part of a shell or shaft thereof.

31. Ski boot according to claim 30 where a ventilation opening of the ski boot tongue assembly overlaps with a respective ventilation opening of the ski boot.

32. Ski boot according to claim 1 where at least one vent has an elongated slot shape.
